(19) United States
(12) Patent Application Publication
(10) Pub. No.: US 2022/0258377 A1
(43) Pub. Date: Aug. 18, 2022

(54) METHOD FOR PRODUCING HONEYCOMB STRUCTURE AND METHOD FOR PRODUCING ELECTRICALLY HEATING SUPPORT

(71) Applicant: NGK INSULATORS, LTD., Nagoya-City (JP)

(72) Inventors: Rina YOKOI, Aisai-City (JP); Masahiro TOKUDA, Kasugai-City (JP); Hironori SUZUKI, Taketoyo-Town (JP)

(73) Assignee: NGK INSULATORS, LTD., Nagoya-City (JP)

(21) Appl. No.: 17/645,781

(22) Filed: Dec. 23, 2021

(30) Foreign Application Priority Data
Feb. 15, 2021 (JP) 2021-022064
Oct. 1, 2021 (JP) 2021-163053

(51) Int. Cl. B28B 3/26; B01J 35/04; B28B 11/24; H05B 3/00

(52) U.S. Cl. CPC B28B 3/269; B01J 35/04; B28B 2003/203; H05B 3/0004; B28B 11/243

(57) ABSTRACT

A method for producing a honeycomb structure includes: a forming step of extruding a forming raw material containing a ceramic raw material to obtain a honeycomb formed body, the honeycomb formed body including: an outer peripheral wall; and partition walls disposed on an inner side of the outer peripheral wall, the partition walls defining a plurality of cells, each of the plurality of cells extending from one end face to the other end face to form a flow passage; a drying step of drying the honeycomb formed body to obtain a honeycomb dried body; and a firing step of firing the honeycomb dried body to obtain a honeycomb fired body. The forming step includes extruding the forming raw material to produce a honeycomb formed body in which a part of the partition walls is lost so that some of the cells are connected to each other.

### FIELD OF THE INVENTION

The present invention relates to a method for producing a honeycomb structure, and a method for producing an electrically heating support.

### BACKGROUND OF THE INVENTION

Recently, electrically heated catalysts (EHCs) have been proposed to improve a decrease in exhaust gas purification performance immediately after engine starting. For example, the EHC is configured to connect metal electrodes to a pillar shaped honeycomb structure made of conductive ceramics, and conducting a current to heat the honeycomb structure itself, thereby enabling a temperature to be increased to an activation temperature of the catalyst prior to the engine starting.

Since the EHCs are subjected to heat and/or impact from an engine, they are required to have good thermal shock resistance. If cracks are generated in the honeycomb structure of the EHC due to heat and/or impact from the engine, the energization passage in the honeycomb structure is changed and localized heat is generated, resulting in degradation of the catalyst. Further, the energization resistance increases, which will be difficult to control the current flow. As a result, an exhaust gas purification efficiency of the EHC may be deteriorated.

Patent Literature 1 discloses a honeycomb structure having improved thermal shock resistance by forming slits that open on a side surface of a honeycomb structure portion. In Patent Literature 1, a honeycomb dried body is formed, and the slits are then formed by cutting partition walls of the honeycomb dried body with Leutor or the like.

Patent Literature 2 discloses a method for forming a slit(s) on an end face of a honeycomb structure. Specifically, it forms the slit by arranging a slit-forming plate member so as to be in contact with one end face of a honeycomb formed body, and moving the slit-forming plate member toward the other end face of the honeycomb formed body while vibrating the slit-forming plate member to cut partition walls of the honeycomb formed body.

### CITATION LIST

### Patent Literatures

[Patent Literature 1] Japanese Patent No. 5997259 B
[Patent Literature 2] Japanese Patent No. 5162509 B

### SUMMARY OF THE INVENTION

Both of the techniques disclosed in Patent Literatures 1 and 2 require the step of forming the slit in the method for producing the honeycomb structure, and the number of operation steps increases accordingly, so that a production efficiency decreases. Further, they have a problem of wear and damage of processing tools for slit formation or the like, which may increase the production cost.

The present invention has been made in light of the above circumstances. A problem of the present invention is to provide a method for producing a honeycomb structure and an electrically heating support, which can form at least one slit in a honeycomb structure with a good production efficiency and production cost.

The above problem is solved by the following present disclosure, and the present disclosure is specified as follows:

(1) A method for producing a honeycomb structure, the method comprising:

a forming step of extruding a forming raw material containing a ceramic raw material to obtain a honeycomb formed body, the honeycomb formed body comprising: an outer peripheral wall; and partition walls disposed on an inner side of the outer peripheral wall, the partition walls defining a plurality of cells, each of the plurality of cells extending from one end face to the other end face to form a flow passage;

a drying step of drying the honeycomb formed body to obtain a honeycomb dried body; and

a firing step of firing the honeycomb dried body to obtain a honeycomb fired body,

wherein the forming step comprises extruding the forming raw material to produce a honeycomb formed body in which a part of the partition walls is lost so that some of the cells are connected to each other.

(2) A method for producing a honeycomb structure, the method comprising:

a forming step of extruding a forming raw material containing a ceramic raw material to obtain a honeycomb formed body, the honeycomb formed body comprising: an outer peripheral wall; and partition walls disposed on an inner side of the outer peripheral wall, the partition walls defining a plurality of cells, each of the plurality of cells extending from one end face to the other end face to form a flow passage;

a drying step of drying the honeycomb formed body to obtain a honeycomb dried body; and

a firing step of firing the honeycomb dried body to obtain a honeycomb fired body,

wherein the forming step comprises extruding the forming raw material to form a honeycomb formed body in which a part of the partition walls is formed thinner than the other partition walls and arranged in a form of a slit.

(3) The method for producing the honeycomb structure according to (1) or (2), wherein the method further comprises the steps of:

applying an electrode portion forming raw material containing a ceramic raw material to a side surface of the honeycomb dried body, and drying the applied electrode portion forming raw material to obtain a honeycomb dried body with unfired electrode portions; and

firing the honeycomb dried body with unfired electrode portions to obtain a honeycomb structure having a pair of electrode portions, and

wherein the pair of the electrode potions are arranged on an outer surface of the outer peripheral wall across a central axis of the honeycomb dried body so as to extend in a form of strip in a flow passage direction of the cells.

(4) A method for producing an electrically heating support, wherein the method comprises a step of electrically connecting a metal electrode to each of the pair of electrode portions of the honeycomb structure produced by the method according to (3).

According to the present invention, it is possible to provide a method for producing a honeycomb structure and an electrically heating support, which can form at least one slit in a honeycomb structure with a good production efficiency and production cost.

### BRIEF DESCRIPTION OF THE DRAWINGS

FIG. 1 is a schematic external view of a honeycomb structure according to an embodiment of the present invention;

FIG. 2 is a schematic cross-sectional view of an electrically heating support according to an embodiment of the present invention, which is perpendicular to an extending direction of cells;

FIG. 3 is specific examples of slit shapes of honeycomb structures according to an embodiment of the present invention;

FIG. 4 (A) is a top view [1], a side view [2], and a bottom view [3] of a U-shaped pin; and FIG. 4 (B) is a top view [1], a side view [2], and a bottom view [3] of a T-shaped pin;

FIG. 5 (A) is a schematic plane view for explaining a state where a slit of a honeycomb formed body is formed using a U-shaped pin; and FIG. 5 (B) is a schematic cross-sectional view of the U-shaped pin and a die in the state corresponding to FIG. 5 (A);

FIG. 6 (A) is a schematic plane view for explaining a state where a slit of a honeycomb formed body is formed by using a T-shaped pin; and FIG. 6 (B) is a schematic cross-sectional view of the T-shaped pin and a die in the state corresponding to FIG. 6 (A);

FIG. 7 (A) is a schematic plane view of a honeycomb formed body which has cells each having a quadrangular cross section and which has a slit formed; and FIG. 7 (B) is a schematic plane view of a honeycomb formed body which has cells each having a hexagonal cross section and which has a slit formed;

FIG. 8 is a schematic plane view of a die having a closed portion;

FIG. 9 is a schematic plane view of a die having a hole formed smaller than other holes;

FIG. 10 is a schematic cross-sectional view of a molding machine for explaining a step of forming a kneaded material in a molding machine;

FIG. 11 (A) is a schematic plane view of a die used in Example 1; FIG. 11 (B) is a schematic plane view of slits produced by FIG. 11 (A); FIG. 11 (C) is a schematic plane view of a die used in Example 2; and FIG. 11 (D) is a schematic plane view of a slit produced by FIG. 11 (C);

FIG. 12 (A) is a schematic plane view of a die used in Example 3; and FIG. 12 (B) is a schematic plane view of slits produced by FIG. 12 (A); and

FIG. 13 (A) is a schematic plane view of a honeycomb formed body which has cells each having a quadrangular cross section and which has a slit formed; and FIG. 13 (B) is a schematic plane view of a honeycomb formed body which has cells each having a hexagonal cross section and which has a slit formed.

### DETAILED DESCRIPTION OF THE INVENTION

Hereinafter, embodiments according to the present invention will be specifically described with reference to the drawings. It is to understand that the present invention is not limited to the following embodiments, and various design modifications and improvements may be made based on ordinary knowledge of a person skilled in the art, without departing from the spirit of the present invention.

### (1. Honeycomb Structure)

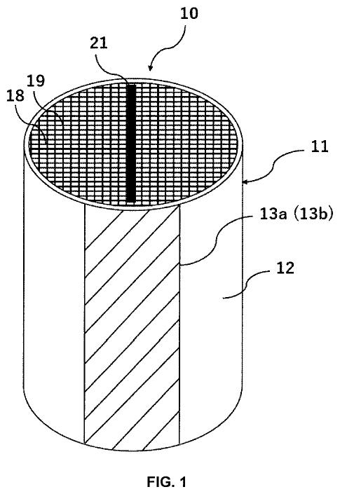

FIG. 1 is a schematic external view of a honeycomb structure 10 according to an embodiment of the present invention. The honeycomb structure 10 includes a pillar shaped honeycomb structure portion 11 and electrode portions 13a, 13b. The honeycomb structure 10 may not include the electrode portions 13a, 13b.

### (1-1. Pillar Shaped Honeycomb Structure Portion)

The pillar shaped honeycomb structure partition 11 includes: an outer peripheral wall 12; and partition walls 19 which are disposed on an inner side of the outer peripheral wall 12 and define a plurality of cells 18 each extending from one end face to the other end face to form a flow passage.

An outer shape of the pillar shaped honeycomb structure portion 11 is not particularly limited as long as it is pillar shaped. For example, the honeycomb structure portion can have a shape such as a pillar shape with circular end faces (cylindrical shape), a pillar shape with oval end faces and a pillar shape with polygonal (quadrangular, pentagonal, hexagonal, heptagonal, octagonal, etc.) end faces. The size of the pillar shaped honeycomb structure portion 11 is such that an area of the end faces is preferably from 2000 to 20000 mm², and more preferably from 5000 to 15000 mm², for the purpose of improving heat resistance (suppressing cracks entering the outer peripheral wall in a circumferential direction).

The pillar shaped honeycomb structure portion 11 is made of a material selected from the group consisting of oxide ceramics such as alumina, mullite, zirconia and cordierite, and non-oxide ceramics such as silicon carbide, silicon nitride and aluminum nitride, although not limited thereto. Silicon carbide-metal silicon composite materials and silicon carbide-graphite composite materials may also be used. Among them, the material of the pillar shaped honeycomb structure portion preferably contains ceramics mainly based on the silicon-silicon carbide composite material or on silicon carbide, in terms of achieving both heat resistant and electrical conductivity. The phrase “the pillar shaped honeycomb structure portion 11 is mainly based on a silicone-silicon carbide composite material” as used herein means that the pillar shaped honeycomb structure portion 11 contains 90% by mass or more of the silicon-silicon carbide composite material (total mass) based on the entire honeycomb structure portion. Here, the silicon-silicon carbide composite material contains silicon carbide particles as an aggregate and silicon as a bonding material for bonding the silicon carbide particles, and a plurality of silicon carbide particles are preferably bonded by silicon so as to form pores between the silicon carbide particles. The phrase “the pillar shaped honeycomb structure portion 11 is mainly based on silicon carbide” as used herein means that the pillar shaped honeycomb structure portion 11 contains 90% by mass or more of the silicon carbide (total mass) based on the entire honeycomb structure portion.

When the pilar shaped honeycomb structure portion 11 contains the silicon-silicon carbide composite material, a ratio of a “mass of silicon as a bonding material” contained in the pillar shaped honeycomb structure portion 11 to the total of a “mass of silicon carbide particles as an aggregate” contained in the pillar shaped honeycomb structure portion 11 and a “mass of silicon as a bonding material” contained in the pillar shaped honeycomb structure portion 11 is preferably from 10 to 40% by mass, and more preferably from 15 to 35% by mass.

A shape of each cell in a cross section perpendicular to an extending direction of the cells 18 is not limited, but it is preferably a quadrangle, a hexagon, an octagon, or a combination thereof. Among these, the quadrangle and the hexagon are preferred, in terms of easily achieving both structural strength and heating uniformity.

Each of the partition walls 19 defining the cells 18 preferably has a thickness of from 0.1 to 0.3 mm, and more preferably from 0.15 to 0.25 mm. As used herein. the thickness of the partition wall 19 is defined as a length of a portion passing through the partition walls 19, among line segments connecting centers of gravity of the adjacent cells 18 in the cross section perpendicular to the extending direction of the cells 18.

The pillar shaped honeycomb structure portion 11 preferably has a cell density of from 40 to 150 cells/cm², and more preferably from 70 to 100 cells/cm², in the cross section perpendicular to the flow passage direction of the cells 18. The cell density in such a range can increase the purification performance of the catalyst while reducing the pressure loss upon flowing of an exhaust gas. The cell density is a value obtained by dividing the number of cells by an area of one end face of the pillar shaped honeycomb structure portion 11 excluding the outer peripheral wall 12 portion.

The provision of the outer peripheral wall 12 of the pillar shaped honeycomb structure portion 11 is useful in terms of ensuring the structural strength of the pillar shaped honeycomb structure portion 11 and preventing a fluid flowing through the cells 18 from leaking from the outer peripheral surface of the pillar shaped honeycomb structure portion 11. More particularly, the thickness of the outer peripheral wall 12 is preferably 0.05 mm or more, and more preferably 0.1 mm or more, and even more preferably 0.15 mm or more. However, if the outer peripheral wall 12 is too thick, the strength becomes too high, so that a strength balance between the outer peripheral wall 12 and the partition wall 19 is lost to reduce thermal shock resistance, and if the thickness of the outer peripheral wall 12 is excessively increased, the heat capacity increases and a temperature difference between the outer peripheral side and the inner peripheral side of the outer peripheral wall 12 increases, so that the heat impact resistance decreases. Therefore, the thickness of the outer peripheral wall 12 is preferably 1.0 mm or less, and more preferably 0.7 mm or less, and still more preferably 0.5 mm or less. As used herein, the thickness of the outer peripheral wall 12 is defined as a thickness of the outer peripheral wall 12 in a direction of a normal line to a tangential line at a measurement point when observing a portion of the outer peripheral wall 12 to be subjected to thickness measurement in the cross section perpendicular to the extending direction of the cells.

The partition walls 19 of the pillar shaped honeycomb structure portion 11 preferably have an average pore diameter of from 2 to 15 μm, and more preferably from 4 to 8 μm. The average pore diameter is a value measured by a mercury porosimeter.

The partition walls 19 may be porous. When the partition walls 19 are porous, the partition wall 19 preferably has a porosity of from 35 to 60%, and more preferably from 35 to 45%. The porosity is a value measured by a mercury porosimeter.

### (1-2. Electrode Portion)

The honeycomb structure 10 according to an embodiment of the present invention includes a pair of electrode portions 13a, 13b on an outer surface of the outer peripheral wall 12 across a central axis of the pillar shaped honeycomb structure portion 11 so as to extend in a form of strip in the flow passage direction of the cells 18. By thus providing the pair of electrode portion 13a, 13b, uniform heat generation of the honeycomb structure 10 can be enhanced. It is desirable that each of the electrode portions 13a, 13b extends over a length of 80% or more, and preferably 90% or more, and more preferably the full length, between both end faces of the honeycomb structure 10, from the viewpoint that a current easily spreads in an axial direction of each of the electrode portions 13a, 13b. It should be noted that the honeycomb structure may not include the electrode portions 13a, 13b.

Each of the electrode portions 13a, 13b preferably has a thickness of from 0.01 to 5 mm, and more preferably from 0.01 to 3 mm. Such a range can allow uniform heat generation to be enhanced. The thickness of each of the electrode portions 13a, 13b is defined as a thickness in a direction of a normal line to a tangential line at a measurement point on an outer surface of each of the electrode portions 13a, 13b when observing the point of each electrode portion to be subjected to thickness measurement in the cross section perpendicular to the extending direction of the cells.

The electric resistivity of each of the electrode portions 13a, 13b is lower than the electric resistivity of the pillar shaped honeycomb structure portion 11, whereby the electricity tends to flow preferentially to the electrode portions 13a. 13b, and the electricity tends to spread in the flow passage direction and the circumferential direction of the cells 18 during electric conduction. The electric resistivity of the electrode portions 13a, 13b is preferably 1/10 or less, and more preferably 1/20 or less, and even more preferably 1/30 or less, of the electric resistivity of the pillar shaped honeycomb structure portion 11. However, if the difference in electric resistivity between both becomes too large, the current is concentrated between ends of the opposing electrode portions to bias the heat generated in the pillar shaped honeycomb structure portion 11. Therefore, the electric resistivity of the electrode portions 13a, 13b is preferably 1/200 or more, and more preferably 1/150 or more, and even more preferably 1/100 or more, of the electric resistivity of the pillar shaped honeycomb structure portion 11. As used herein, the electric resistivity of the electrode portions 13a, 13b is a value measured at 25° C. by a four-terminal method.

Each of the electrode portions 13a, 13b may be made of conductive ceramics, a metal, and a composite of a metal and conductive ceramics (cermet). Examples of the metal include a single metal of Cr, Fe, Co, Ni, Si or Ti, or an alloy containing at least one metal selected from the group consisting of those metals. Non-limiting examples of the conductive ceramics include silicon carbide (SiC), metal compounds such as metal silicides such as tantalum silicide (TaSi₂) and chromium silicide (CrSi₂). Specific examples of the composite of the metal and the conductive ceramics (cermet) include a composite of metal silicon and silicon carbide, a composite of metal silicide such as tantalum silicide and chromium silicide, metal silicon and silicon carbide, and further a composite obtained by adding to one or more metals listed above one or more insulating ceramics such as alumina, mullite, zirconia, cordierite, silicon nitride, and aluminum nitride, in terms of decreased thermal expansion.

### (1-3. Slit)

In a cross section perpendicular to a flow passage direction of the cells 18 of the honeycomb structure 10, at least one linear slit 21 is provided. By having such a linear slit 21, cracking on the end faces of the honeycomb structure 10 can be suppressed. The provision of the above linear slit 21 can relax stress to reduce a thermal expansion difference, so that the cracking can be well suppressed.

In FIG. 1, the slit 21 indicates a position thereof in the honeycomb structure 10, and its shape is not particularly limited as long as it is elongated. Further, the slit 21 has a shape such that adjacent cells are connected to each other by removing the partition walls 19 between them. The slit 21 is preferably in a form where the slit extends in the extending direction of the cells and is provided on both end faces.

The shape and number of slits 21 are not particularly limited and can be designed as needed. For example, two, or four or more slits 21 may be independently formed. By having a plurality of slits formed independently, the generation of cracks in the honeycomb structure 10 can be well controlled. The width of each slit 21 are not particularly limited. The width of the slit may be formed to be the same as the width of each cell 18, or the width of each slit may be formed smaller or larger than that of each cell 18. The width of each slit is not particularly limited, but it may be from 1 to 30 cm. The width of each slit 21 can be adjusted depending on the size, materials, and applications of the honeycomb structure 10, and the number of slits and the length of the slit.

In an embodiment of the present invention, the slit 21 preferably passes through the center of the pillar shaped honeycomb structure portion 11 in the cross section perpendicular to the flow passage direction of the cells of the pillar shaped honeycomb structure portion 11. Such a configuration can lead to better control of changes in resistance and current passage of the honeycomb structure 10. Each slit may be divided into sections along an extending direction of the slits. In this case, the slit 21 may be divided into slits having the same length or different lengths. By dividing and forming the slit, the generation of cracks in the honeycomb structure 10 can be well controlled. The number of the slits divided is not particularly limited, but each slit 21 may be divided into two, three, or four or more sections. In addition, the honeycomb structure may be provided with a plurality of slits consisting of the combination of divided slits and non-divided slits.

A ratio of the length of the slit 21 to an outer diameter of the pillar shaped honeycomb structure portion 11 is preferably 25% or more. The ratio of the length of the slit 21 to the outer diameter of the pillar shaped honeycomb structure 11 of 25% or more can allow thermal shock to be better relaxed and cracking to be better suppressed.

It is preferable that a depth of the slit 21 in the flow passage direction of the cells 18 from one end face in the honeycomb structure 10 is from 30 to 100% of the full length of the pillar shaped honeycomb structure portion 11. The depth of the slit 21 of from 30 to 100% of the full length of the pillar shaped honeycomb structure portion 11 can lead to improvement of thermal shock resistance. The depth of the slit 21 is preferably from 50 to 100%, even more preferably from 70 to 100%, of the full length of the pillar shaped honeycomb structure portion 11.

Specific examples of shapes of the slits 21 are shown in (A) to (L) of FIG. 3. It should be noted that each of (A) to (L) of FIG. 3 only shows the outer diameter of the end face of the pillar shaped honeycomb structure portion 11 and the shape of the slit.

The slit 21 may pass through the center and extend to the outer periphery on both sides on the end face of the pillar shaped honeycomb structure 11, as shown in FIG. 3 (A), or it may pass through the center and extend to the middle without reaching the outer periphery, as shown in FIG. 3 (B), or it may pass through the center and have any slope, as shown in FIG. 3 (C), or the slits may not pass through the center, as shown in FIG. 3 (D).

The slits 21 may be composed of a slit passing through the center and extending to the outer periphery on the end face of the pillar shaped honeycomb structure 11 and a plurality of slits extending parallel to both sides of that slit, as shown in FIG. 3 (E), or one slit may intersect with the other slit at any angle, as shown in FIG. 3 (F), or a plurality of slits may intersect with the other slit at any angle, as shown in FIG. 3 (G).

The slit 21 may entirely interrupted and divided on the end face of the pillar shaped honeycomb structure portion 11, as shown in FIG. 3 (H), or it may be interrupted and divided only near the outer periphery, as shown in FIG. 3 (I), or slits entirely interrupted and divided intersect with each other, as shown in FIG. 3 (J).

The slits 21 may be formed only near the outer periphery including the outer peripheral wall, on the end face of the pillar shaped honeycomb structure portion 11, as shown in FIG. 3 (K), or they may be provided only near the outer periphery including the outer peripheral wall, and divided, as shown in FIG. 3 (L).

### (2. Electrically Heating Support)

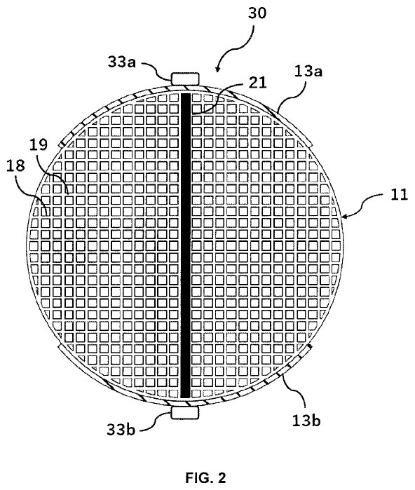

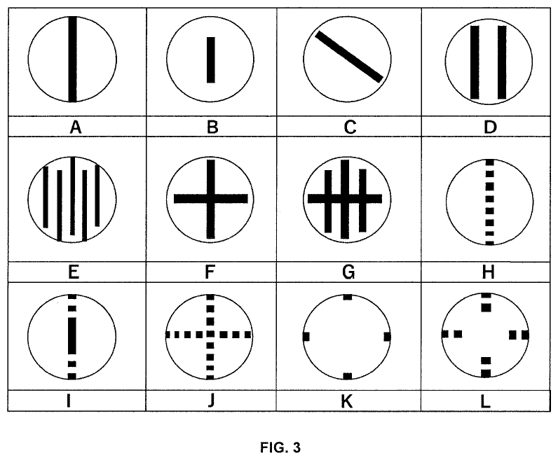

FIG. 2 is a schematic cross-sectional view of an electrically heating support 30 according to an embodiment of the present invention, which is perpendicular to the extending direction of the cells. The electrically heating support 30 includes: the honeycomb structure 10; and metal electrodes 33a, 33b electrically connected to the electrode portions 13a, 13b of the honeycomb structure 10, respectively.

### (2-1. Metal Electrode)

Metal electrodes 33a, 33b are provided on the electrode portions 13a, 13b of the honeycomb structure 10. The metal electrode 33a, 33b may be a pair of metal electrode such that one metal electrode 33a is disposed so as to face the other metal electrode 33b across the central axis of the pillar shaped honeycomb structure portion 11. As a voltage is applied to the metal electrodes 33a, 33b through the electrode portions 13a, 13b, then the electricity is conducted through the metal electrodes 33a, 33b to allow the pillar shaped honeycomb structure portion 11 to generate heat by Joule heat. Therefore, the electrically heating support 30 can also be suitably used as a heater. The applied voltage is preferably from 12 to 900 V, and more preferably from 48 to 600 V, although the applied voltage may be changed as needed.

The material of the metal electrodes 33a, 33b is not particularly limited as long as it is a metal, and a single metal, an alloy, or the like can be employed. In terms of corrosion resistance, electrical resistivity and linear expansion coefficient, for example, the material is preferably an alloy containing at least one selected from the group consisting of Cr, Fe, Co, Ni and Ti, and more preferably stainless steel and Fe—Ni alloys. The shape and size of each of the metal electrodes 33a, 33b are not particularly limited, and they can be appropriately designed according to the size of the electrically heating support 30, the electrical conduction performance, and the like.

By supporting the catalyst on the electrically heating support 30, the electrically heating support 30 can be used as a catalyst. For example, a fluid such as an exhaust gas from a motor vehicle can flow through the flow passages of the plurality of cells 18 of the honeycomb structure 10. Examples of the catalyst include noble metal catalysts or catalysts other than them. Illustrative examples of the noble metal catalysts include a three-way catalyst and an oxidation catalyst obtained by supporting a noble metal such as platinum (Pt), palladium (Pd) and rhodium (Rh) on surfaces of pores of alumina and containing a co-catalyst such as ceria and zirconia, or a NOx storage reduction catalyst (LNT catalyst) containing an alkaline earth metal and platinum as storage components for nitrogen oxides (NO.). Illustrative examples of a catalyst that does not use the noble metal include a NOx selective reduction catalyst (SCR catalyst) containing a copper-substituted or iron-substituted zeolite, and the like. Further, two or more catalysts selected from the group consisting of those catalysts may be used. A method for supporting the catalyst is not particularly limited, and it can be carried out according to a conventional method for supporting the catalyst on the honeycomb structure.

### (3. Method for Producing Honeycomb Structure)

Next, a method for producing the honeycomb structure according to an embodiment of the present invention will be described.

The method for producing the honeycomb structure according to an embodiment of the present invention includes: a forming step of obtaining a honeycomb formed body; a drying step of obtaining a honeycomb dried body; and a firing step of obtaining a honeycomb fired body.

### (Forming Step)

In the forming step, first, a forming raw material containing a ceramic raw material is prepared. The forming raw material is prepared by adding metal silicon powder (metal silicon), a binder, a surfactant(s), a pore former, water, and the like to silicon carbide powder (silicon carbide). It is preferable that a mass of metal silicon is from 10 to 40% by mass relative to the total of mass of silicon carbide powder and mass of metal silicon. The average particle diameter of the silicon carbide particles in the silicon carbide powder is preferably from 3 to 50 μm, and more preferably from 3 to 40 μm. The average particle diameter of the metal silicon (the metal silicon powder) is preferably from 2 to 35 μm. The average particle diameter of each of the silicon carbide particles and the metal silicon (metal silicon particles) refers to an arithmetic average diameter on volume basis when frequency distribution of the particle size is measured by the laser diffraction method. The silicon carbide particles are fine particles of silicon carbide forming the silicon carbide powder, and the metal silicon particles are fine particles of metal silicon forming the metal silicon powder. It should be noted that this is the formulation of the forming raw material in the case where the material of the honeycomb structure is the silicon-silicon carbide composite material, and when the material of interest is silicon carbide, no metal silicon is added.

Examples of the binder include methyl cellulose, hydroxypropylmethyl cellulose, hydroxypropoxyl cellulose, hydroxyethyl cellulose, carboxymethyl cellulose, polyvinyl alcohol and the like. Among these, it is preferable to use methyl cellulose in combination with hydroxypropoxyl cellulose. The content of the binder is preferably from 2.0 to 10.0 parts by mass when the total mass of the silicon carbide powder and the metal silicon powder is 100 parts by mass.

The content of water is preferably from 20 to 60 parts by mass when the total mass of the silicon carbide powder and the metal silicon powder is 100 parts by mass.

The surfactant that can be used includes ethylene glycol, dextrin, fatty acid soaps, polyalcohol and the like. These may be used alone or in combination of two or more. The content of the surfactant is preferably from 0.1 to 2.0 parts by mass when the total mass of the silicon carbide powder and the metal silicon powder is 100 parts by mass.

The pore former is not particularly limited as long as the pore former itself forms pores after firing, including, for example, graphite, starch, foamed resins, water absorbing resins, silica gel and the like. The content of the pore former is preferably from 0.5 to 10.0 parts by mass when the total mass of the silicon carbide powder and the metal silicon powder is 100 parts by mass. An average particle diameter of the pore former is preferably from 10 to 30 μm. The average particle diameter of the pore former refers to an arithmetic average diameter on volume basis when frequency distribution of the particle size is measured by the laser diffraction method. When the pore former is the water absorbing resin, the average particle diameter of the pore former refers to an average particle diameter after water absorption.

The resulting forming raw material is then kneaded to form a green body, and the green body is then extruded to prepare a honeycomb formed body. The honeycomb formed body includes: the outer peripheral wall; and the partition walls which are disposed on the inner side of the outer peripheral wall and define the plurality of cells each extending from one end face to the other end face to form the flow passage.

The honeycomb formed body has a part of the partition walls being lost so that some of the cells are connected to each other. By producing such a honeycomb formed body in which a part of the partition walls is lost so that some of the cells are connected to each other, the connected cells form the slit(s), and any step of forming the slit(s) by cutting or the like become unnecessary after the subsequent drying step. Therefore, a production efficiency is improved. It can also eliminate a problem of wear and damage to processing tools used to form the slit(s), thereby reducing the production cost. Furthermore, when the slit is formed by cutting or the like, it may cause a problem that the slit penetrates into adjacent cells. However, the present invention forms the slit shape at the stage of forming the honeycomb formed body, so that the slit penetration into the adjacent cells can be well controlled.

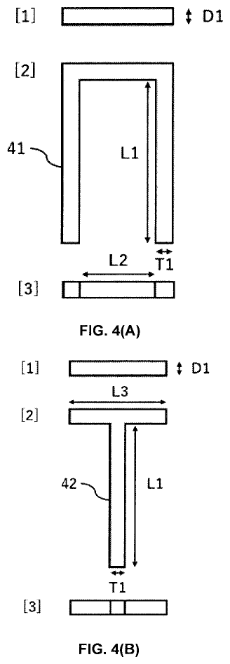

The honeycomb formed body in which a part of the partition walls is lost so that some of the cells are connected to each other can be produced using a molding machine having a die in which some of holes are blocked by inserting a pin(s). The shape of the pin is not limited, but for example, a U-shaped pin 41 as shown in FIG. 4 (A) or a T-shaped pin 42 as shown in FIG. 4 (B) may be used.

FIG. 4 (A) shows a top view [1], a side view [2], and a bottom view [3] of the U-shaped pin 41. FIG. 4 (B) shows a top view [1], a side view [2], and a bottom view [3] of the T-shaped pin 42.

It is preferable that a width D1 on an upper surface of each of the U-shaped pin 41 and the T-shaped pin 42 is from 0.9 to 1.2 times a distance of the slit in a width direction (opening distance). According to such a configuration, the generation of a slit portion (also called a burr) that cannot be fully removed by the U-shaped pin 41 and the T-shaped pin 42 can be suppressed. The suppression of the generation of the burr leads to easy filling of the slit with a filling material from the outer peripheral side. The width D1 on the upper surface of each of the U-shaped pin 41 and the T-shaped pin 42 may be from 0.4 to 1.4 mm, for example.

It is preferable that a leg length L1 of each of the U-shaped pin 41 and the T-shaped pin 42 is substantially the same as a height of a cell block 44 of a die 43 so that the pin inserted into the die 43 is difficult to pull out therefrom. The leg length L1 of each of the U-shaped pin 41 and the T-shaped pin 42 may be from 1.5 to 6.0 mm, for example.

It is preferable that a leg thickness T1 of each of the U-shaped pin 41 and the T-shaped pin 42 is preferably 0.9 to 1.1 times the distance of the cell block 44 so as to prevent a green body from flowing into the slit forming portion of the die 43 and to prevent the pin from falling out during molding. The leg thickness T1 of each of the U-shaped pin 41 and the T-shaped pin 42 may be from 0.06 to 0.28 mm, for example.

It is preferable that a table length L2 of the U-shaped pin 41 is such that the legs of the U-shaped pin 41 are parallelly inserted into the holes of the die 43. For example, the table length L2 of the U-shaped pin 41 may be from 0.45 to 1.3 mm.

It is preferable that a shoulder length L3 of the T-shaped pin 42 is such that the pin 42 does not penetrate into the partition wall adjacent to the slit. The shoulder length L3 of the T-shaped pin 42 may be from 1.1 to 2.6 mm, for example.

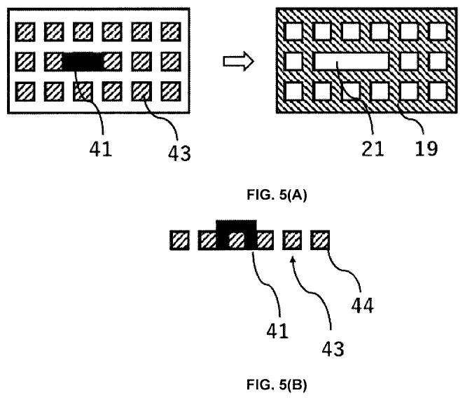

FIG. 5 (A) is a schematic plane view for explaining a state where the slit of the honeycomb formed body is formed using the U-shaped pin. FIG. 5 (B) is a schematic cross-sectional view of the U-shaped pin and the die in the state corresponding to FIG. 5 (A). As shown on the left side of FIG. 5 (A) and FIG. 5 (B), the U-shaped pin 41 can be inserted into holes of the die 43 of the molding machine and a green body can be extruded from the die in that state to produce a honeycomb formed body in which a part of the partition walls 19 is lost to form a linear slit 21, as shown on the right side of FIG. 5 (A). By providing a series of U-shaped pins 41, a longer linear slit can be formed. Also, by providing a plurality of U-shaped pins 41 apart from each other by a predetermined number of holes of the die 43, the divided slits can be formed.

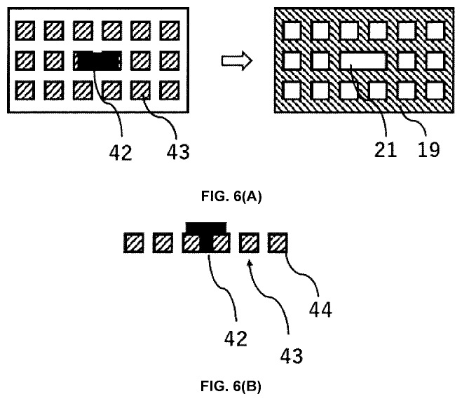

FIG. 6 (A) is a schematic plane view for explaining a state where the slit of the honeycomb formed body is formed by using the T-shaped pin. FIG. 6 (B) is a schematic cross-sectional view of the T-shaped pin and the die in the state corresponding to FIG. 6 (A). As shown on the left side of FIG. 6 (A) and FIG. 6 (B), the T-shaped pin 42 can be inserted into the hole of the die 43 of the molding machine and a green body can be extruded from the die in that state to produce a honeycomb formed body in which a part of the partition walls 19 is lost to form a linear slit 21, as shown on the right side of FIG. 6 (A). By providing a series of T-shaped pins 42, a longer linear slit can be formed. Also, by providing a plurality of T-shaped pins 42 apart from each other by a predetermined number of holes in the die 43, the divided slits can be formed.

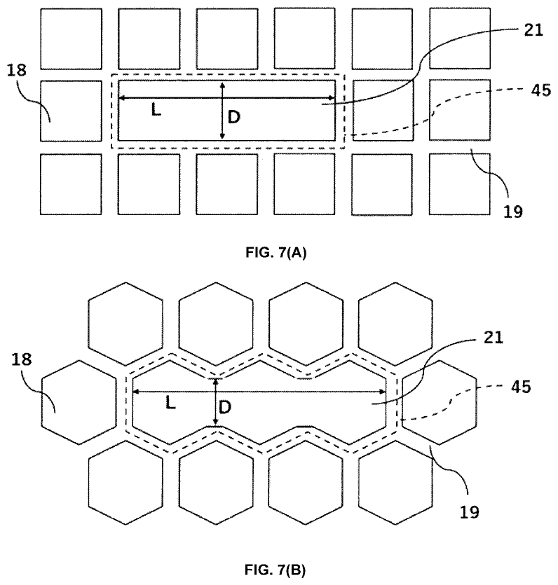

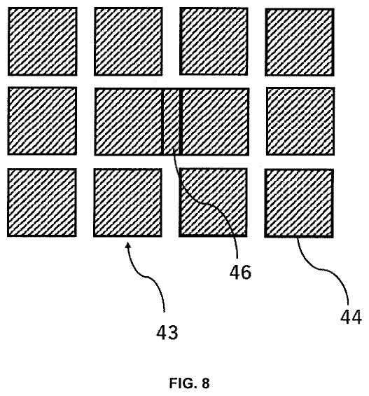

FIG. 7 (A) shows a schematic cross-sectional view of a honeycomb formed body in which each of cells 18 has a quadrangular cross-sectional shape. FIG. 7 (B) shows a schematic cross-sectional view of a honeycomb formed body in which each of the cells 18 has a hexagonal cross-sectional shape. Here, a ratio L/D of a length L to a width D of the slit 21 is preferably from 1 to 5 when the cell structure is quadrangular, and from 1.5 to 8 when the cell structure is hexagonal. It is more preferable that the ratio L/D is 4 or less when the cell structure is quadrangular, and 6 or less when the cell structure is hexagonal, because the deformation of the slit 21 can be satisfactorily suppressed. More preferably, the ratio L/D is from 1 to 4 when the cell structure is quadrangular, and from 1.5 to 6 when the cell structure is hexagonal.

In FIG. 7 (A) and FIG. 7 (B), a region 45 shown by the dotted line is a partition wall portion located around the slit 21, which is cut at a position of half the thickness of the partition wall to surround the slit 21. A ratio of an area of the slit 21 to an area of the region 45 (opening ratio) is preferably from 67 to 90%. The opening ratio of 90% or less can allow the deformation of the slit 21 to be suppressed more satisfactorily.

The U-shaped pin 41 or T-shaped pin 42 may be made of any material such as metals and resins, but it is preferable to use cemented carbide or SUS to prevent deformation or damage during molding.

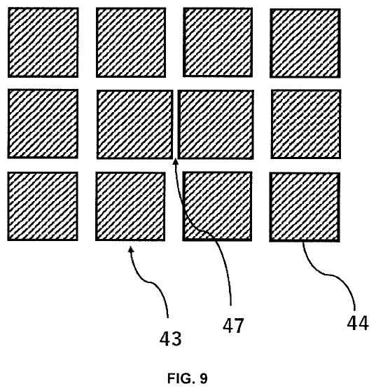

The honeycomb formed body in which a part of the partition walls is lost so that some of the cells are connected to each other can be produced by extrusion molding of the honeycomb formed body using a molding machine with a die in which some of the holes are closed. As shown in FIG. 8, the holes of the die 43 can be closed to form a block portion 46, thereby forming the slit at positions corresponding to the cell block 44 of the die 43 and the block portion 46 in the honeycomb formed body extruded and formed by the molding machine. The block portion 46 may be integrally formed with the cell block 44 of the die 43, or a separate block portion 46 made of the same or different material as that of the cell block 44 may be provided between the cell blocks 44 of the die 43.

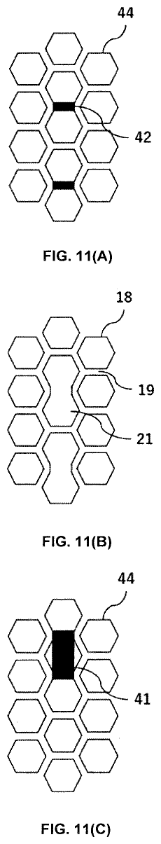

The honeycomb formed body in which a part of the partition walls is lost so that some of the cells are connected to each other can be produced by extrusion molding of the honeycomb formed body using a molding machine having a die and a noodle which is provided on an upstream side of a passage of a forming raw material relative to the die, and in which some of the holes are closed. FIG. 10 illustrates an example of a schematic cross-sectional view of the molding machine 22 to describe a step of forming a kneaded material 23 in the molding machine 22. In the molding machine 22, the kneaded material 23 is extruded to pass through a screen 24, a noodle 25, and a drawing jig 26, and formed by a die 27 to produce a honeycomb formed body 28. The screen 24 is provided to block the inflow of coarse particles of the raw material and to prevent clogging of the die. The noodle 25 is provided to support the screen 24. The drawing jig 26 is provided to draw the kneaded material 23 to a diameter of the die 27. The screen 24, the noodle 25, and the drawing jig 26 are provided on the upstream side of the passage of the forming raw material relative to the die 27, as shown in FIG. 10. In the molding machine 22 having such a structure, some of the holes of the noodle 25 can be closed to form the slit 21 at the positions corresponding to the closed holes of the noodle 25 in the honeycomb formed body 28 extruded from the die 27.

The honeycomb formed body in which a part of the partition walls is lost so that some of the cells are connected to each other can be produced by preparing a forming raw material having holes that can form a honeycomb formed body in which a part of the partition walls is lost during extrusion molding by kneading, and then extruding the forming raw material. The forming raw material prepared by the kneading is also called a kneaded material, which is made of soil (ceramic material) and water, and is generally formed in a cylindrical shape. By forming holes in advance in the part of the kneaded material where the slit is desired to be formed, it is possible to form a honeycomb formed body in which the partition walls are lost at the positions corresponding to the holes during the extrusion molding.

The honeycomb formed body may have a structure in which a part of the partition walls is formed thinner than the other partition walls and arranged in the form of slit. By thus producing the honeycomb formed body in which a part of the partition walls is formed thinner than the other partition walls and arranged in the form of slit, the thinner partition walls can be scrapped after the subsequent drying step to form the slit easily. Thus, by forming a part of the partition walls thinner than the other partition walls, rather than completely removing a part of the partition walls, the honeycomb shape can be retained during the drying and firing steps. A length of the portion where a part of the partition walls is formed thinner than the other partition walls and arranged in the form of slit is preferably from 50 to 100%, more preferably from 70 to 100%, of a length of a linear slit of a final product (honeycomb structure), in terms of improving a production efficiency and production cost. The length of the linear slit of the final product (honeycomb structure) may be from 1 to 200 mm.

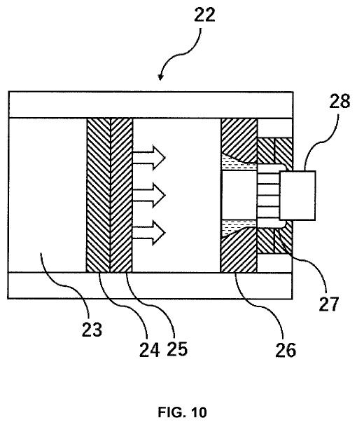

The honeycomb formed body in which a part of the partition walls is formed thinner than the other partition walls can be produced by extrusion molding of the honeycomb formed body using a molding machine having a die in which a part of holes is formed smaller than the other holes. As shown in FIG. 9, for the holes between the cell blocks 44 of the die 43, a hole 47 formed smaller than the other holes can be provided, whereby a part of the partition walls corresponding to the hole 47 in the honeycomb formed body obtained by the extrusion molding can be formed thinner than the other partition walls.

### (Drying Step)

The resulting honeycomb formed body is then dried to produce a honeycomb dried body. The drying method is not particularly limited. Examples include electromagnetic wave heating methods such as microwave heating/drying and high-frequency dielectric heating/drying, and external heating methods such as hot air drying and superheated steam drying. Among them, it is preferable to dry a certain amount of moisture by the electromagnetic wave heating method and then dry the remaining moisture by the external heating method, in terms of being able to dry the entire molded body quickly and evenly without cracking. As for conditions of drying, it is preferable to remove 30 to 99% by mass of the water content before drying by the electromagnetic wave heating method, and then reduce the water content to 3% by mass or less by the external heating method. The dielectric heating/drying is preferable as the electromagnetic heating method, and hot air drying is preferable as the external heating method. The drying temperature may preferably be from 50 to 120° C.

### (Firing Step)

The resulting honeycomb dried body is then fired to produce a honeycomb fired body. As the firing conditions, the honeycomb dried body is preferably heated in an inert atmosphere such as nitrogen or argon at 1400 to 1500° C. for 1 to 20 hours. After firing, an oxidation treatment is preferably carried out at 1200 to 1350° C. for 1 to 10 hours in order to improve durability. The methods of degreasing and firing are not particularly limited, and they can be carried out using an electric furnace, a gas furnace, or the like.

The honeycomb fired body may be used as a honeycomb structure as it is. The method for producing the honeycomb structure with electrode portions is carried out by, first, applying the electrode portion forming raw material containing ceramic raw materials to the side surface of the honeycomb dried body and drying it to form a pair of unfired electrode portions on the outer surface of the outer peripheral wall, across the central axis of the honeycomb dried body, so as to extend in the form of strip in the flow direction of the cells, thereby providing a honeycomb dried body with unfired electrode portions. The honeycomb dried body with unfired electrode portions is then fired to provide a honeycomb fired honeycomb body having a pair of electrode portions. The honeycomb structure with the electrode portions is thus obtained. In addition, the electrode portions may be formed after the honeycomb fired body is produced. Specifically, once the honeycomb fired body is produced, a pair of unfired electrode portions may be formed on the honeycomb fired body, and fired to produce the honeycomb fired body with the pair of electrode portions.

The electrode portion forming raw material can be formed by appropriately adding and kneading various additives to raw material powder (metal powder, and/or ceramic powder, and the like) formulated according to required characteristics of the electrode portions. When each electrode portion is formed as a laminated structure, the joining strength between each metal terminal and each electrode portion tends to be improved by increasing an average particle diameter of the metal powder in the paste for the second electrode portion, as compared with an average particle diameter of the metal powder in the paste for the first electrode portion. The average particle diameter of the metal powder refers to an arithmetic average diameter on volume basis when frequency distribution of the particle diameter is measured by the laser diffraction method.

The method for preparing the electrode portion forming raw material and the method for applying the electrode portion forming raw material to the honeycomb fired body can be performed according to a known method for producing a honeycomb structure. However, in order to achieve lower electrical resistivity of the electrode portions than that of the honeycomb structure portion, it is possible to increase a metal content ratio or to decrease the particle diameter of the metal particles as compared with the honeycomb structure portion.

Before firing the honeycomb dried body with unfired electrode portions, degreasing may be carried out in order to remove the binder and the like. As the firing conditions for the honeycomb dried body with unfired electrode portions, the honeycomb dried body with unfired electrode portions is preferably heated in an inert atmosphere such as nitrogen and argon at 1400 to 1500° C. for 1 to 20 hours. After firing, an oxidation treatment is preferably carried out at 1200 to 1350° C. for 1 to 10 hours in order to improve durability. The methods of degreasing and firing are not particularly limited, and they can be carried out using an electric furnace, a gas furnace, or the like.

### (4. Method for Producing Electrically Heating Support)

In one embodiment of the method for the electrically heating support 30 according to the present invention, a metal electrode is electrically connected to each of the pair of electrode portions on the honeycomb structure 10. Examples of the connecting method includes laser welding, thermal spraying, ultrasonic welding, and the like. More particularly, a pair of metal electrodes are provided on the surfaces of the electrode portions across the central axis of the pillar shaped honeycomb structure portion 11. The electrically heating support 30 according to an embodiment of the present invention is thus obtained.

### (5. Exhaust Gas Purifying Device)

The electrically heating support according to the above embodiment of the present invention can be used for an exhaust gas purifying device. The exhaust gas purifying device includes the electrically heating support and a metallic cylindrical member for holding the electrically heating support. In the exhaust gas purifying device, the electrically heating support can be installed in an exhaust gas flow passage for allowing an exhaust gas from an engine to flow.

### EXAMPLES

Hereinafter, Examples is illustrated for better understanding of the present invention and its advantages, but the present invention is not limited to these Examples.

### Example 1

### (1. Production of Green Body)

Silicon carbide (SiC) powder and metal silicon (Si) powder were mixed in a mass ratio of 80:20 to prepare a ceramic raw material. To the ceramic raw material were added hydroxypropylmethyl cellulose as a binder, a water absorbing resin as a pore former, and water to form a forming raw material. The forming raw material was then kneaded by means of a vacuum green body kneader to prepare a cylindrical green body (a kneaded material). The content of the binder was 7.0 parts by mass when the total of the silicon carbide (SiC) powder and the metal silicon (Si) powder was 100 parts by mass. The content of the pore former was 3.0 parts by mass when the total of the silicon carbide (SiC) powder and the metal silicon (Si) powder was 100 parts by mass. The content of water was 42 parts by mass when the total of the silicon carbide (SiC) powder and the metal silicon (Si) powder was 100 parts by mass. The average particle diameter of the silicon carbide powder was 20 μm, and the average particle diameter of the metal silicon powder was 6 μm. The average particle diameter of the pore former was 20 μm. The average particle diameter of each of the silicon carbide powder, the metal silicon powder and the pore former refers to an arithmetic average diameter on volume basis, when measuring frequency distribution of the particle size by the laser diffraction method.

### (2. Production of Honeycomb Formed Body)

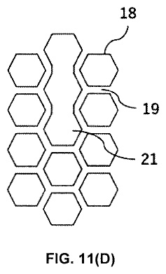

Next, a molding machine having the die structure as shown in FIG. 10 was prepared. FIG. 11 (A) shows a schematic plane view of the die used in Example 1. The cell block 44 of the die was hexagonal, and the T-shaped pin 42 having the structure shown in FIG. 4 (B) was inserted into the hole between the cell blocks 44 of the die. Table 1 shows the width D1, the leg length L1, the leg thickness T1, and the shoulder length L3 of the T-shaped pin 42. The T-shaped pins 42 were provided at intervals of two cell blocks from each other in the cells arranged on one straight line.

The resulting cylindrical green body (kneaded material) was formed using the above molding machine to produce a honeycomb formed body in which a part of the partition walls was lost so that some cells were connected to each other. The slits 21 as shown in FIG. 11 (B) were formed on the end faces of the resulting honeycomb formed body, and as a whole, the slits that were interrupted and divided were formed as shown in FIG. 3 (H).

### (3. Production of Honeycomb Dried Body)

The honeycomb formed body was dried by high frequency dielectric heating, and then dried at 120° C. for 2 hours using a hot air dryer to produce a honeycomb dried body.

### (4. Preparation of Electrode Portion Forming Paste and Production of Honeycomb Fired Body)

Metal silicon (Si) powder, silicon carbide (SiC) powder, methyl cellulose, glycerin, and water were mixed in planetary centrifugal mixer to prepare an electrode portion forming paste. The Si powder and the SiC powder were blended so that the volume ratio was Si powder:SiC powder=40:60. Further, when the total of the Si powder and the SiC powder was 100 parts by mass, methyl cellulose was 0.5 parts by mass, glycerin was 10 parts by mass, and water was 38 parts by mass. The average particle diameter of the metal silicon powder was 6 μm. The average particle diameter of the silicon carbide powder was 35 μm. The average particle diameter of each of those powders refers to an arithmetic average diameter on a volume basis when frequency distribution of particle diameters is measured by the laser diffraction method.

The electrode portion forming paste was then applied to the honeycomb dried body with an appropriate area and film thickness by a curved surface printing machine and further dried at 120° C. for 30 minutes in a hot air dryer. The honeycomb dried body was then fired in an Ar atmosphere at 1400° C. for 3 hours to obtain a honeycomb structure. Table 1 shows a cell pitch of the obtained honeycomb structure and a thickness (rib thickness) of the partition wall 19.

The pillar shaped honeycomb structure had circular end faces each having an outer diameter (diameter) of 100 mm, a height (length in the flow passage direction of the cells) of 100 mm, and a thickness of the outer peripheral wall of 0.5 mm. The thickness of each partition was 0.19 mm, the porosity of the partition walls was 45%, and the average pore diameter of the partition walls was 8.6 μm. The thickness of each electrode portion was 0.3 mm. Further, as shown in FIG. 7 (B), the ratio L/D of the length L to the width D of the slit 21, and a ratio of the area of the slit 21 to the area of the region where the partition walls located around the slit 21 were cut at a position of half the thickness of the slit 21 to surround the slit 21 (opening ratio) were measured. Table 1 shows the measurement results of L/D and the opening ratio.

### Example 2

A honeycomb structure in which a part of the partition walls was lost so that some cells were connected to each other were produced by the same method as that of Example 1, with the exception that the U-shaped pin 41 having the structure shown in FIG. 4 (A) was inserted into the holes between the cell blocks 44 of the die of the molding machine as shown in FIG. 11 (C). The width D1, leg length L1, leg thickness T1, and table length L2 of the U-shaped pin 41 are shown in Table 1. The U-shaped pins 41 were provided at intervals of two cell blocks from each other in the cells arranged on one straight line. Table 1 also shows the cell pitch of the obtained honeycomb formed body and the thickness of each partition wall 19 (rib thickness). On each end face of the obtained honeycomb formed body, the slits 21 were formed as shown in FIG. 11 (D), and as a whole, the slits were interrupted and divided as shown in FIG. 3 (H).

### Example 3

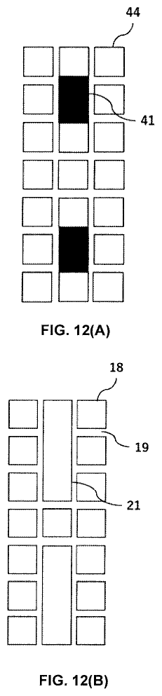

A honeycomb structure in which a part of the partition walls was lost so that some cells were connected to each other was produced in the same method as that of Example 1, with the exception that each cell block 44 of the die was quadrangular and the U-shaped pin 41 of the structure shown in FIG. 4 (A) was inserted into the holes between the cell blocks 44 of the die as shown in FIG. 12 (A). The width D1, leg length L1, leg thickness T1, and table length L2 of the U-shaped pin 41 are shown in Table 1. The U-shaped pins 41 were provided at intervals of three cell blocks from each other in the cells arranged on one straight line. Table 1 also shows the cell pitch of the obtained honeycomb formed body and the thickness of each partition wall 19 (rib thickness). On each end face of the obtained honeycomb formed body, the slits 21 were formed as shown in FIG. 12 (B), and as a whole, the slits were interrupted and divided as shown in FIG. 3 (H).

### Example 4

A honeycomb structure in which a part of the partition walls was lost so that some cells were connected to each other was produced by the same method as that of Example 2, with the exception that the extrusion molding was carried out to form the slit using a die with some holes closed without using the U-shaped pin 41. The closed holes in the die were at the same positions as the holes into which the U-shaped pin 41 was inserted in Example 2. The cell pitch of the obtained honeycomb formed body and the thickness of each partition wall 19 (rib thickness) are shown in Table 1. On each end face of the obtained honeycomb formed body, the slit 21 were formed as shown in FIG. 11 (D), and as a whole, the slit was interrupted and divided as shown in FIG. 3 (H).

### <Deformation Evaluation>

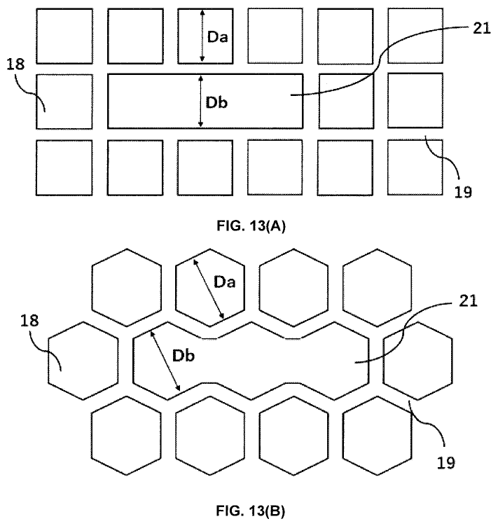

As shown in FIG. 13, a rate of change of the cell width Db in the slit formed portion relative to the cell width Da in the non-slit formed portion for each of the quadrangular and hexagonal cells: [(Db−Da)/Da]×100(%) was measured, and a degree of deformation of each honeycomb structure was evaluated by that rate of change. A lower rate of change means a lower change in the width of the cells in the slit formed portion. The evaluation results are shown in Table 1. As can be seen from Table 1, the rate of change is less than 10% or less than 20% for Examples 1 to 4, indicating that the deformation of the honeycomb structure is well suppressed.

TABLE 1

| | | Example 1 | Example 2 | Example 3 | Example 4 |
|---|---|---|---|---|---|
| Cell | Cell Block | Hexagonal | Hexagonal | Quadrangular | Hexagonal |
| | Cell Pitch (mm) | 1.04 | 1.04 | 1.04 | 1.04 |
| | Rib Thickness (mm) | 0.19 | 0.14 | 0.13 | 0.14 |
| Pin (mm) | Width D1 | 0.6 | 0.6 | 1.0 | — |
| | Leg Length L1 | 3.0 | 3.0 | 3.0 | — |
| | Leg Thickness T1 | 0.190 | 0.125 | 0.125 | — |
| | Table Length L2 | — | 1.1 | 1.0 | — |
| | Shoulder Length L3 | 1.75 | — | — | — |
| Slit | L/D | 3.6 | 5.6 | 3.2 | 5.6 |
| | Opening Ratio (%) | 72 | 81 | 86 | 81 |

| | | | | |
|---|---|---|---|---|
| Rate of Change | less than 10% | less than 10% | 10% or more | less than 10% |
| | | | less than 20% | |

### DESCRIPTION OF REFERENCE NUMERALS

10 honeycomb structure
11 pillar shaped honeycomb structure portion
12 outer peripheral wall
13a, 13b electrode portion
18 cell
19 partition wall
21 slit
22 molding machine
23 kneaded material
24 screen
25 noodle
26 drawing jig
27 die
28 honeycomb formed body
30 electrically heating support
33a, 33b metal electrode
41 U-shaped pin
42 T-shaped pin
43 die
44 cell block
45 region
46 block portion
47 hole

1. A method for producing a honeycomb structure, the method comprising:
a forming step of extruding a forming raw material containing a ceramic raw material to obtain a honeycomb formed body, the honeycomb formed body comprising: an outer peripheral wall; and partition walls disposed on an inner side of the outer peripheral wall, the partition walls defining a plurality of cells, each of the plurality of cells extending from one end face to the other end face to form a flow passage;
a drying step of drying the honeycomb formed body to obtain a honeycomb dried body; and
a firing step of firing the honeycomb dried body to obtain a honeycomb fired body,
wherein the forming step comprises extruding the forming raw material to produce a honeycomb formed body in which a part of the partition walls is lost so that some of the cells are connected to each other.

2. The method for producing the honeycomb structure according to claim 1, wherein the forming step comprising using a molding machine having a die in which a part of holes is closed by inserting at least one pin to produce the honeycomb formed body in which a part of the partition walls is lost.

3. The method for producing the honeycomb structure according to claim 1, wherein the forming step comprises using a molding machine having a die in which a part of holes is closed to produce the honeycomb formed body in which a part of the partition walls is lost.

4. The method for producing the honeycomb structure according to claim 1, wherein the forming step comprises using a molding machine having: a die; and a noodle provided at the die on an upstream side of a passage of the forming raw material, a part of holes of the noodle being closed, to produce the honeycomb formed body in which a part of the partition walls is lost.

5. The method for producing the honeycomb structure according to claim 1, wherein the method comprises forming a forming raw material having at least one hole capable of forming the honeycomb formed body in which a part of the partition walls is lost during extrusion molding, and extruding the forming raw material to form the honeycomb formed body in which a part of the partition walls is lost.

6. The method for producing the honeycomb structure according to claim 1, wherein the honeycomb structure has at least one linear slit including the cells, the at least one linear slit being formed by removing a part of the partition walls, in a cross section perpendicular to a flow passage direction of the cells.

7. A method for producing a honeycomb structure, the method comprising:
a forming step of extruding a forming raw material containing a ceramic raw material to obtain a honeycomb formed body, the honeycomb formed body comprising: an outer peripheral wall; and partition walls disposed on an inner side of the outer peripheral wall, the partition walls defining a plurality of cells, each of the plurality of cells extending from one end face to the other end face to form a flow passage;
a drying step of drying the honeycomb formed body to obtain a honeycomb dried body; and
a firing step of firing the honeycomb dried body to obtain a honeycomb fired body,
wherein the forming step comprises extruding the forming raw material to form a honeycomb formed body in which a part of the partition walls is formed thinner than the other partition walls and arranged in a form of a slit.

8. The method for producing the honeycomb structure according to claim 7, wherein the forming step comprises using a molding machine having a die in which a part of holes is formed smaller than other holes to produce the honeycomb formed body in which a part of the partition walls is formed thinner than the other partition walls.

9. The method for producing the honeycomb structure according to claim 1, wherein the method further comprises the steps of:
applying an electrode portion forming raw material containing a ceramic raw material to a side surface of the honeycomb dried body, and drying the applied electrode portion forming raw material to obtain a honeycomb dried body with unfired electrode portions; and
firing the honeycomb dried body with unfired electrode portions to obtain a honeycomb structure having a pair of electrode portions, and
wherein the pair of the electrode potions are arranged on an outer surface of the outer peripheral wall across a central axis of the honeycomb structure so as to extend in a form of strip in the flow passage direction of the cells.

10. A method for producing an electrically heating support, wherein the method comprises a step of electrically connecting a metal electrode to each of the pair of electrode portions of the honeycomb structure produced by the method according to claim 9.
